(19) United States
(12) Patent Application Publication
(10) Pub. No.: US 2005/0174238 A1
(43) Pub. Date: Aug. 11, 2005

(54) Theft protection plug for electrical devices

(76) Inventor: Knut Foseide, Oslo (NO)

Correspondence Address: YOUNG & THOMPSON, 745 SOUTH 23RD STREET, 2ND FLOOR, ARLINGTON, VA, 22202, US

(21) Appl. No.: 10/478,660

(22) PCT Filed: May 28, 2002
(86) PCT No.: PCT/NO02/00189

(30) Foreign Application Priority Data
May 29, 2001 (NO) 2001 2619

(51) Int. Cl. G08B 13/12

(52) U.S. Cl. 340/568.4

(57) ABSTRACT

The invention relates to a theft protection plug which is mounted externally on electrical devices having a corresponding receptacle, and which, in addition to being capable of functioning as a connector plug, has a theft protection function, where the alarm electronics are encapsulated in the rear part of the theft protection plug. According to the invention, an anti-theft alarm is incorporated into a plug of any type—which thus protects the piece of equipment to which the theft protection plug is connected against theft or unauthorized removal, and can provide control over the location of different types of equipment in a chosen area. The degree of theft protection is higher if the plug is held in place in its respective receptacle by a locking mechanism.

### 1. DEFINITIONS

Theft protection plug (TPP)—a plug equipped with alarm electronics which, according to the invention, must be incorporated into the rear part of the theft protection plug the part of the plug which projects from the receptacle when connected.

Plug—a standard plug (RS232, USB or similar) for electrical devices.

Alarm device—a signal unit which emits/does not emit a signal to indicate a given state.

Theft registration sensor—a sensor which registers that someone is trying to steal the equipment that is to be protected.

Power source—power source which energises the alarm electronics according to the invention.

Connector plug—double or branching plug where wires are drawn through the plug for possible connection of another plug.

### 2. DESCRIPTION

The invention relates to a theft protection plug which is mounted externally on electrical devices having a corresponding receptacle, and which, in addition to being capable of functioning as a connector plug, has a theft protection function, where the alarm electronics are encapsulated in the rear part of the theft protection plug.

The theft prevention products for electrical devices available today are not satisfactory solutions, and do not provide adequate protection against many opportunist thieves. The theft protection plug is designed to prevent thefts of electrical devices, in particular during the day, from premises where even good access control is not enough to stop the thieves.

According to the invention, an anti-theft alarm is incorporated into a plug of any type—which thus protects the piece of equipment to which the theft protection plug is connected against theft or unauthorised removal, and can provide control over the location of different types of equipment in a chosen area. The degree of theft protection is higher if the plug is held in place in its respective receptacle by a locking mechanism.

According to the applicant, an audible anti-theft alarm for electrical devices should be based on two important criteria: 1) The alarm device must be placed inside or against the cover of the device to be protected, primarily to make the destruction or dampening of the alarm device very difficult, but also to be able to control the alarm via the receptacle on the piece of equipment to be protected. 2) The alarm device should be physically locked in the device to be protected to prevent so-called “hit and run” thefts where the alarm is cut off, pulled off or removed in some other way from the device to be protected, whereupon the thief takes the device and leaves the alarm behind at the scene of the crime.

The said criteria can be met by an alarm-supplying unit incorporated into a standard plug (RS232, USB or the like) for electrical devices because:
1) Not all electrical devices have space available for internal installation.
2) It simplifies installation/removal of the alarm.
3) It allows the alarm signals to be fed into the cover of the piece of equipment to be protected, thereby making it difficult to dampen the alarm signals if anyone tries to do so.

The theft prevention plug according to the invention allows an alarm device to change the signal it normally gives when the piece of equipment to be protected is moved, or when an attempt is made to disconnect the theft protection plug from the piece of equipment to be protected. Detection of motion and disconnection can be effected in a number of ways as described in more detail later in the application. Protection of equipment is obtained according to the invention in that the theft protection plug is plugged into a receptacle on the piece of equipment to be protected.

An essential feature of the theft protection plug according to the invention is that the alarm device is placed as close as possible to the device to be protected, and also that the alarm device casing can be locked to the device to be protected.

Theft protection of electrical devices is obtained according to the invention in that one or more alarm devices emit a signal different from the signal it or they normally emit if an attempt is made to move the piece of electrical equipment, or an attempt is made to remove the theft protection plug from the piece of electrical equipment, where the alarm device is encapsulated in the rear part of the plug (FIG. x)+b)) so that:
1. The TPP can be controlled by the piece of equipment it protects via the port to which it connected. This allows, inter alia, a reduction in the size of the unit.
2. The TPP is simple to disconnect from and connect to the piece of equipment to be protected, which is necessary for mobile equipment (portable electrical units).
3. The user has the opportunity to lock the contact with the alarm electronics in a communication port on the piece of equipment to be protected in such manner that the thief would have to destroy essential parts of the product in order to be able to steal it.
4. The alarm device is protected from an unauthorised person dampening the alarm signal by putting the alarm device in a bucket of water or the like.
   If the alarm device had been placed on the outside of the piece of equipment to be protected or, e.g., merely been fastened to the piece of equipment with a wire, chain, adhesive, tape or in some other manner which makes it easily accessible to the thief, the thief could have put the alarm device in a vessel containing water, thereby preventing the alarm signal from reaching the desired receiver, when he pulled it out or in some other way removed the theft protection unit from the device to be protected.
5. Physical destruction of the alarm device by using, e.g., blows of a hammer sledgehammer, by drilling, using pliers etc. will be made difficult.
   The device to be protected stands in the way of the tool when the attempt is made, thereby preventing the tool from reaching the critical components.
   The device to be protected may be destroyed instead of the alarm device during an attempt of this kind to tamper with the device
6. It is more difficult to dampen the alarm signals by covering the alarm device with alarm signal muffling material as for instance a bundle of wet cloth, metal cladding or the like;
   Because the alarm signal muffling material does not reach around the whole alarm device.
   Because the area around the theft protection plug receptacle on the electrical device is not normally completely level (because of the frame around the receptacle, other contacts/cables and chassis screws etc.), which makes it difficult to suppress the alarm signal even with an efficient muffling material.
   On a number of electrical devices in the area of application of the theft protection plug, there are gaps and holes around the receptacle which will admit the alarm signals into the actual casing around the device to be protected, so that the alarm signals from the alarm device are not dampened sufficiently in all instances, provided that the alarm device is located in the theft protection plug.
7. If the alarm signal is an audible signal, the sound from the signal unit will be amplified by reflection against the device chassis (in the area around the theft protection plug receptacle).
   Sound holes or a sound diaphragm in connection with the alarm device can be directed towards the chassis of the device, so that the amplitude of the sound waves reflected from the chassis will be amplified by interference in the points of intersection between the sound waves which cross.
8. Sound holes can be made in front of the rear part of the theft protection plug, so that when an unauthorised person begins to pull the theft protection plug out of the device to be protected, the following happens:
   The sound is amplified considerably in that it is passed directly from the resonance chamber in the rear part of the theft protection plug out through open holes.
   The sound from the resonance chamber is passed directly into the wall of the device chassis, which reflects it so that the amplitude is further amplified because of interference.
   According to the inventor, open sound holes are only suitable when placed in front of the rear part of the theft protection plug or in the front part of the theft protection plug, because unauthorised persons could otherwise fill the resonance chamber with sound-dampening material, as for instance foam, liquid or the like. There is 1-3 mm of air in this gap also, which lets sound out straight out of the resonance chamber even when the theft protection plug is fully inside the device receptacle.
      2.1 Different Applications for Different Intended Uses

When the theft protection plug is used as theft protection for electrical equipment in institutions where an unauthorised person may operate unseen, such as in schools and hospitals etc, it is just as necessary that the alarm device should be encapsulated in the theft protection plug as that the theft protection plug has a locking mechanism which fastens it to the device receptacle.

When the theft protection plug is to be used as protection for goods on display in electrical and computer shops, at trade fairs and the like, the encapsulation of the alarm device in the plug is necessary, whereas the locking mechanism in the theft protection plug may be unnecessary if the premises are surveyable and manned.

The other features of the invention relates to all intended uses.

2.2 Different Embodiments and Solutions Capable of Incorporation Into a Theft Protection Plug

The electrical and mechanical solutions which can be used to obtain protection according to the invention are many and can basically be chosen from all known techniques for anti-theft alarms, but the following examples may constitute satisfactory protection against theft:

2.2.1 Alternative Embodiments, Electronics

2.2.1.1 Simplest Embodiment:

The TPP may consist solely of an alarm device (e.g., ultrasound), and may in that case transmit, e.g., a regular signal to a receiver/central unit or the like.

The TPP can be supplied with power from the piece of equipment it protects through the receptacle to which it is connected. Alternatively, the TPP can be supplied with power from an internal power source, which may be a battery or the like. If it is only supplied with power from the piece of equipment, the receiver/central unit can register an alarm when ultrasound from the TPP switches from one central unit to another, or when ultrasound is switched off (e.g., because the plug is disconnected from the piece of equipment and loses its power source).

A USB plug is suitable for the purposes of the invention to protect portable computers, whilst another type of contact may be best for other mobile equipment. In its simplest form, the TPP has only an alarm device unit incorporated therein—which consists of an alarm device and its supporting components. A relay may also be connected so that the PC simply switches the relay on or off, which in turn opens or closes the circuit which activates or deactivates the alarm device. All other embodiments mentioned later in this application can also be drawn into this embodiment as additional features in order, inter alia, to increase the degree of security of the product.

2.2.1.2 Combined Embodiment:

The TPP may have both an ultrasonic transmitter and an analog sound transmitter as alarm device, and each of these can be activated or deactivated separately. The TPP may have a mercury switch and a microswitch as sensors.

The TPP can be supplied with power from an internal battery or accumulator, and may optionally be supplied with charging current from the piece of equipment it protects.

Communication via equipment that is protected activates and controls all the functions in the TPP, and can also be used to program the TPP's control circuit if so desired. The TPP can control and/or be programmed via an alarm control unit if the communication with the TPP is two-way, and if the TPP has a built-in receiver for ultrasound, sound, RF or the like. The TPP can be incorporated into the rear part of a standard USB plug.

Remarks:

In the above, it has only been considered important to mention the main components of the circuits. However, other components which are necessary to implement the described functionality, but which are prior art, are also present. Several of the components can be incorporated into a IC/MCU that is connected to the alarm electronics.

2.2.1.3 Alarm Devices

The TPP may have an ultrasonic transmitter as alarm device. The ultrasonic transmitter may have its own identification in the form of frequency, pulse or prior art for differentiation of/communication with ultrasonic signals. In addition to basic identification, the ultrasonic transmitter can also communicate a status report to a receiver or central unit.
The TPP may use a standard sound transmitter as local alarm, and this is recommended, preferably a piezoelectric sound transmitter incorporated directly into the rear part of the plug, where the plug per se is a part of the resonance chamber. The sound should be passed out through sound holes/diaphragms or the like in the front of the TPP—so that the sound is thrown in towards the piece of equipment that is protected and becomes more difficult to dampen.
The TPP can use radio waves/RF transmitter and optionally a receiver for one-way or two-way communication with an alarm control unit/receiver.
The TPP may also use all types of known communications technology.
All said alarm device embodiments may either transmit an alarm signal when a particular criterion for this is given (sensor), or transmit a monitoring signal normally and indicate an alarm at the receiver when the signal ceases.

The TPP may use one of the aforementioned alarm devices separately or several simultaneously, in combination with 0 or more of the sensors, locking mechanisms, power sources, on/off means/control circuits and the other alternatives that are outlined in this application.

2.2.1.4 Sensors

A number of solutions can be used as a sensor which registers that a state of alarm has been reached in the TPP.
The TPP may have a motion detector in the form of, e.g., a mercury switch integral with the alarm circuit, so that the TPP triggers the alarm the instant someone tries to move the piece of equipment to be protected. The TPP can also use other types of tilt switches. If the TPP just uses a sound transmitter as alarm device, the motion detector is the only solution that is satisfactory, but it should be combined with a physical sensor to ensure that the TPP is connected to the piece of equipment to be protected (see below). Other motion detectors the TPP can use include a photocell or phototransistor, other phototechnology, IR or known techniques for registration of motion.
In addition to a motion detector, the TPP may also have a physical sensor in the form of a microswitch that is connected in connection with the receptacle on the piece of equipment to be protected, so that the microswitch changes state when the plug is connected to/disconnected from the receptacle. The microswitch will then directly or via a pressure transmitting part close or open a circuit which results in the alarm device(s) entering the alarm state.
As an alternative physical sensor, the TPP may have contact points, contact pins or other conductive material coupled at at least two points which are connected to/disconnected from any conductive material (connector shield, contact pins, screws or the like) in the receptacle on the piece of equipment to be protected.
The TPP may also have as alarm sensor the feature that it registers the state between one or more pins in the piece of equipment to be protected, and triggers an alarm state when given criteria are present. All known techniques may be used to register electrical change of state. This may also be standard communication with the equipment to be protected, e.g., with a PC having the theft protection plug connected via a USB port. The PC can also, via contact pins, control a relay in the theft protection plug (TPP), which in turn controls the alarm.

The TPP may use one of the aforementioned sensors separately or several simultaneously, in combination with 0 or more of alarm devices, locking mechanisms, power sources, on/off means/control circuits and the other alternatives that are outlined in this application.

2.2.1.5 Power Sources

The TPP may be supplied with power from an internal power source (a battery or the like) located in the rear part of the TPP. The TPP may be supplied with power from the piece of equipment it protects through the receptacle to which it is connected. An optional internal accumulator in the TPP can be supplied with charging current from the piece of equipment it protects via the receptacle. The TPP may have a separate external charger which is connected when the theft protection plug is not in use, and is not connected to the piece of equipment it protects. The ultrasonic transmitter in the TPP (which transmits at regular intervals) may be supplied with power from the piece of equipment that is protected whilst a standard sound transmitter may be supplied with power from an internal battery.

An internal power source in the TPP may also be a capacitor which is charged from the piece of equipment that is protected, and supplies current pulses to an alarm device when required.

2.2.1.6 User Interface

The TPP can communicate direct with the equipment that is protected. A relay in the TPP can also be connected to one or more pins in the receptacle on the piece of equipment to be protected, and software in the piece of equipment to be protected can control the functions in the theft protection plug via the plug. Alternatively, the functions of the theft protection plug can be controlled via ultrasound or an RF receiver or the like from an alarm control unit when a two-way communication system is used. It is possible that the functions of the TPP are controlled by a keypad located on the TPP itself and having code functionality. The functions of the TPP may be controlled by a key, magnetic key, electronic key, various scanner techniques or other known authentication techniques. The TPP may be controlled by a simple on/off switch or a simple code keypad or the like which the user operates directly on the TPP, and in that case the access to the switch/keypad can be placed in the front of the TPP—so that the plug must be disconnected and the alarm triggered before the user can, if he wishes, switch it off.

2.2.1.7 Control Circuits

The alarm electronics may be controlled by a relay or relays or the like. The alarm electronics may be controlled by a microcontroller. The alarm electronics may be controlled by one or more integrated circuits/ASIC.

The alarm electronics in the TPP may be controlled by one or more of said alternatives, or combinations thereof.

2.2.1.8 Other Features

The TPP can communicate with the piece of equipment it protects—via an associated communication receptacle where one or more components in the TPP can be connected to two or more pins in the receptacle, so that by means of special software in the piece of equipment to be protected it is possible to encode or lock the software contents of the equipment/PC/PDA or the like, so that it does not work or cannot be read by unauthorised persons. The solution may also contain the possibility of the alarm device entering the alarm state if an unauthorised person attempts to use the piece of equipment that is protected, e.g., if the wrong password is entered once or a given number of times.

The unit may have a battery strength indicator which, e.g., emits a signal from one of the signal units if the battery strength falls below a given level, and the battery must be changed or charged.

Methods of Communication With the Central Unit

The unit (TPP) can communicate with an alarm control unit in all known ways for ultrasonic/RF communication, one-way or two-way. The alarm control unit can relay the signals to a local or external computer network, to a telephone, a mobile telephone, pager or the like.

2.2.2 Alternative Embodiments, Locking Mechanisms

The TPP may have a grip hook (12) which on connection is moved into one or more cavities or edges in the inner wall, inside the receptacle on the piece of equipment to be protected.
The grip hook (12) can move into cavities/edges in that it is moved by any type of load or motion transmission mechanism (13) such as a lever, hinge joint, lifting groove, springs, a round arm with a locking pin which can be turned or another known technique for mechanical load transfer and locking systems in general.
The TPP may also have a coil magnet which releases the locking mechanism when a given criterion is met. The locking mechanism holds the TPP in place in its respective receptacle, and can be opened, e.g., via a keypad/coil magnet (opens, e.g., on deactivation of the alarm). The coil magnet can draw power from the battery in the TPP. The coil magnet can draw power through the receptacle from the piece of equipment that is protected.
Alternatively, the whole locking mechanism can be opened or closed by a long screw which is also connected to the alarm circuit and which triggers the alarm when someone starts to turn the screw, but where the screw must be turned for some time before the locking mechanism is released.
The locking piece may form electric contact with one or more contact pins in the receptacle, thus enabling the alarm electronics to use the locking piece as an electrical conductor for communication with the piece of equipment to which it is connected, power supply, registration of connection to the piece of equipment it protects and so forth.
The grip hook (12) can be so designed on the opposite side that it presses the hook further into the cavity (11) in the receptacle the more the plug is pulled on. The grip hook can be fastened in any one of the walls of the receptacle, if there is a recess/cavity/edge (11) in which the grip hook (12) can grip.

The object of the locking mechanism is also that the thief damages the receptacle on the piece of equipment that is protected if he attempts to break the theft protection plug off the piece of equipment to be protected.
In another embodiment, the TPP may be locked permanently in the receptacle by a clamping mechanism around the contact pins.
In yet another embodiment, the locking piece can expand out towards the walls of the receptacle from the TPP, thereby locking the TPP in place.
If the receptacle on the equipment to be protected has fastening screws, the TPP can be fastened using standard fastening screws in connection with the receptacle. The fastening screws may be alarmed in that a circuit is connected to one end of the screw, and the circuit loop is further connected to the alarm circuit via the other end of the screw, so that the alarm is triggered when the circuit changes state.

The TPP can use the aforementioned locking mechanism solutions separately or several simultaneously, in combination with 0 or more of the sensors, user interfaces, power sources, alarm devices and the other alternatives that are outlined in this application.

2.2.3 Alternative Embodiments, Types of Plugs

The TPP may be a simple type of plug for electrical devices, e.g., a USB plug type “A”. The TPP may also be a fully functioning double plug or connector plug which means that other devices can be connected to the same port as the TPP. The TPP can be incorporated into a USB plug, RS232 plug, PCMCIA plug, RJ45 or the like, a jack plug, a phonoplug or any other type of known plug. The TPP can be used to protect portable computers, hand-held electrical devices, mobile telephones, audio and video equipment etc from theft.

A key ring cover can also be made in the form of a corresponding receptacle for the TPP, having a hole therein in so that it can be connected to a key ring and plugged into the TPP when the TPP is not in use, to protect and store the TPP.

2.2.4 Alternative Embodiments, Cover

The TPP may have an internal accumulator which is charged via the receptacle from the equipment that is protected or via a separate charger, and in that case the TPP can have a fully closed cover that cannot be opened.
The TPP may have a battery which must be changed when it is flat. The battery access can then be from the front of the plug, so that the TPP must first be disconnected from the receptacle on the piece of equipment that is protected and then a long screw must be unscrewed before the battery can be changed.
If the TPP has a closed cover and only ultrasound which is operated from SW in the piece of equipment and transmits a current pulse at intervals which is registered by an alarm control unit/receiver, the TPP may then have a capacitor, coil, battery or the like which amplifies the voltage from the piece of equipment.
2.2.5 Materials Selection

The rear part of the theft protection plug may be a metal box (for example, aluminium) or the whole theft protection plug can be moulded in plastic (e.g., glass-reinforced polyamides). If the theft protection plug is moulded in plastic, the alarm device can be placed in a “box” of spring steel which protects and triggers microswitches/pressure sensors/IR located inside the box of spring steel.

The locking mechanism may be made in its entirety of metal (e.g., steel), or it can be made of hard plastic with a metal piece for the part that presses its way out of the theft protection plug and into the receptacle.

The rear part of the TPP may be of plastic, but reinforced with a safety grille, a metal screen or the like.

2.3 Conclusion

One or more alternative embodiments of electronics can be combined with one or more of the alternative embodiments of locking mechanisms, plugs, cover or material.

### 3 EXPLANATION OF THE FIGURES

3.1 FIG. 1, Simplest embodiment—1

The example shows a USB plug (0) with an alarm device (1) built into its rear part. The alarm device may, e.g., be energised by power (2) from the piece of equipment that is protected, supplied via the receptacle to which the TPP is connected.

3.2 FIG. 2, Simplest embodiment—2

The embodiment may also include the feature that the power from the piece of equipment that is protected can be connected to a relay (3) or similar in the TPP, which controls the alarm electronics. A power source (4) may also be placed inside the TPP to energise the alarm device.

3.3 FIG. 3, Combined embodiment—1

The figure shows how an alarm circuit can simply be arranged. The power source (4) energizes an alarm circuit where the alarm signal transmitter (1a and 1b) and sensors (5a and 5b) are series connected, with the option of disconnecting 1b from the circuit through a signal selection switch (6). The sensors (5a and 5b) may normally be open, and close the circuit between the power source and the battery if the alarm criteria are given. A sensor may also be connected to the circuit only via a relay (as 5a), so that the sensor changes the state of the relay by opening a circuit between the relay and a secondary power source (DC) if the sensor is given alarm criteria. The secondary power source may be any one of those mentioned under the different embodiments of power sources earlier in the application. The alarm can be activated or deactivated using any key type (3) or in that (3) can contain, e.g., a relay which opens/closes the alarm circuit, and is controlled through current signals (2) from the piece of equipment to be protected.

3.4 FIG. 4, Combined embodiment—2

FIG. 4 shows an alarm circuit controlled by a control circuit (7) which is energised by a power source (4). The control circuit interprets the state of the sensors (5a and 5b) and gives an alarm signal via the signal transmitter (1a and 1b) when given criteria are met. The control circuit (7) may be a microcontroller, or an integrated circuit, an ASIC, or, e.g., a set of relays and other necessary components. The control circuit may also be connected to the contact pins in the TPP so that the alarm can communicate with the piece of equipment that is protected. The piece of equipment that is protected can activate or deactivate the alarm, choose between the use of one or more signal transmitters, or, e.g., also trigger an alarm if given states in the piece of equipment that is protected indicate that this should be done (e.g., the alarm can be triggered if someone tries to enter the wrong password in a portable computer to which the TPP is connected). Connector pins in the figure can also be replaced by any type of key, keypad or other authentication unit in order to control the control circuit.

3.5 FIG. 5, Example of a microswitch as sensor

FIGS. 5a, b and c show an example of how microswitches can be placed in a USB plug type “A” to register when it is connected and when it is not connected in its respective receptacle. FIG. 5a shows the USB plug (0) from above with the microswitch (9) placed with the pressure arm facing the receptacle and placed inside the front part just far enough to ensure that the microswitch is pressed in when the plug (0) is right inside its receptacle. FIG. 5b shows the USB plug (0) from the side with the microswitch positioned in the same way. FIG. 5c shows the USB plug (0) from in front with the microswitch (9) positioned in the same way.

3.6 FIG. 6, Example of contact points as sensor—1

FIGS. 6a, b and c show an example of how contact pins can be placed in a USB plug type “A” to register when it is and when it is not connected to its respective receptacle. FIG. 5a shows the USB plug (0) from above with the contact pins (10a and 10b) placed with so that they have electrical contact with the connector shield around the USB receptacle when plug is connected thereto. FIG. 5b shows the USB plug (0) from the side with the microswitch positioned in the same way. FIG. 5c shows the USB plug (0) from in front with the microswitch (9) positioned in the same way.

3.7 FIG. 7, Example of contact points as sensor—2

FIG. 7 shows the front part of the USB plug (0), where the contact pins (10) consist of a contact pin in the plug that is divided into two, and where each part has an electrical conductor connected thereto, which is in turn connected to the alarm circuit, and constitutes a possible sensor. When the TPP is inside the receptacle, the two parts will be connected together electrically by the contact pin in the receptacle, and these will lose contact when the TPP is disconnected.

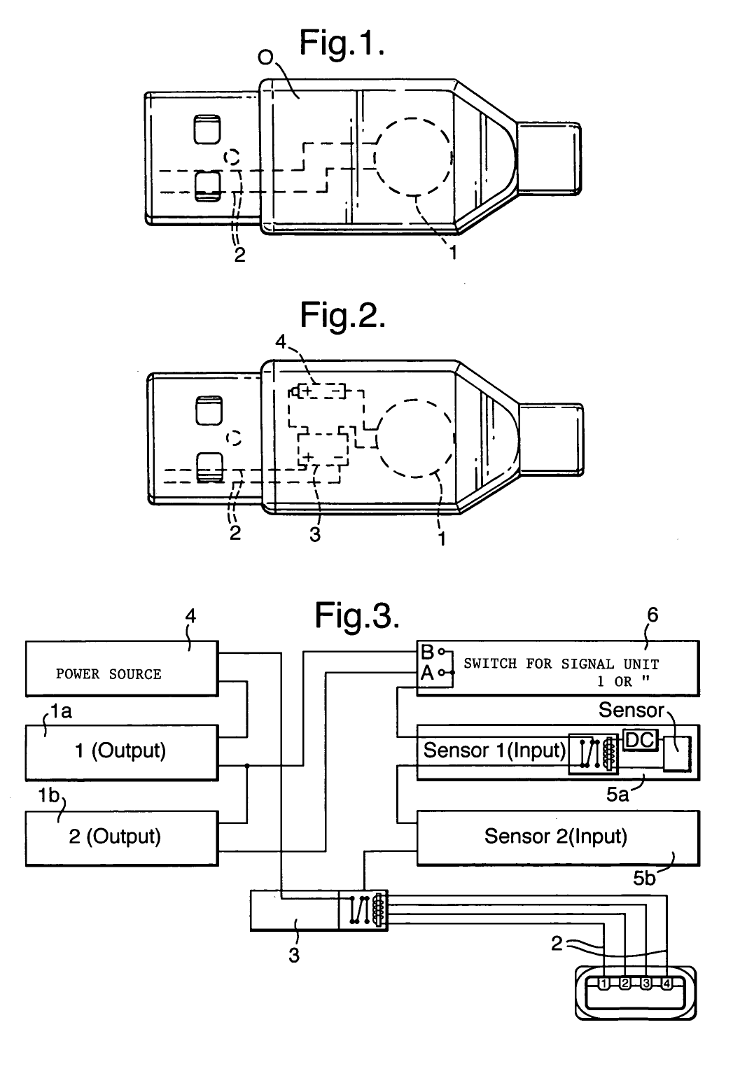

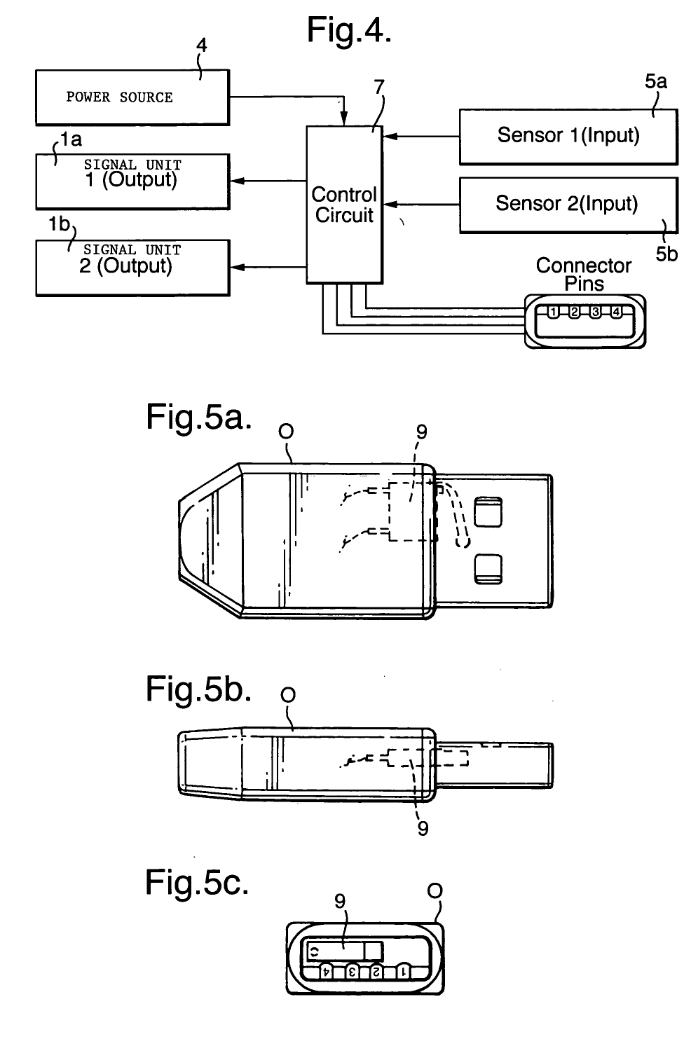

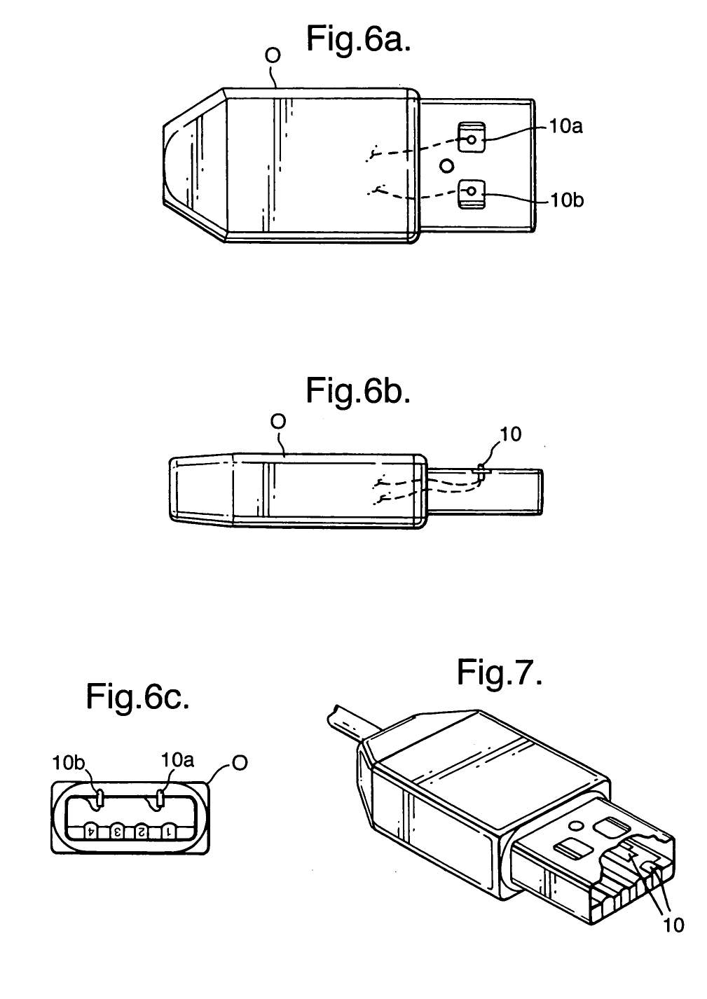

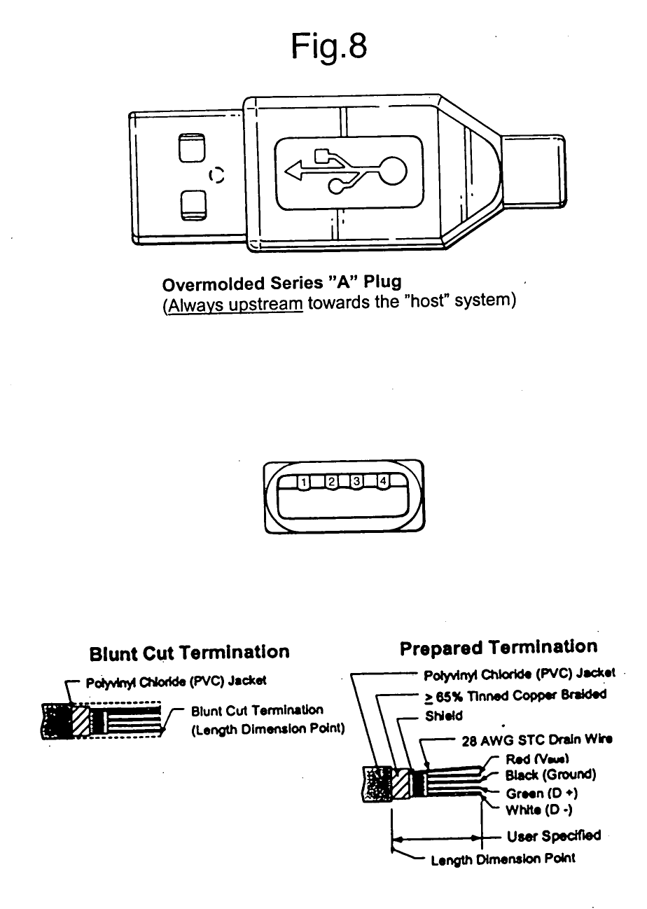

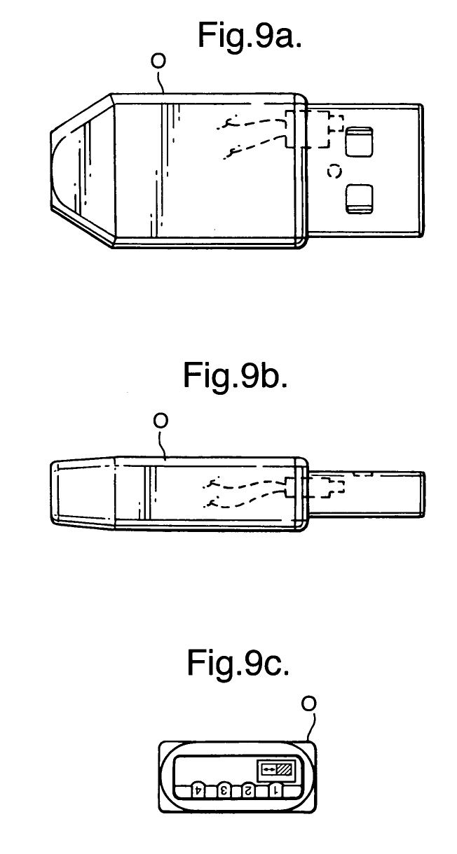

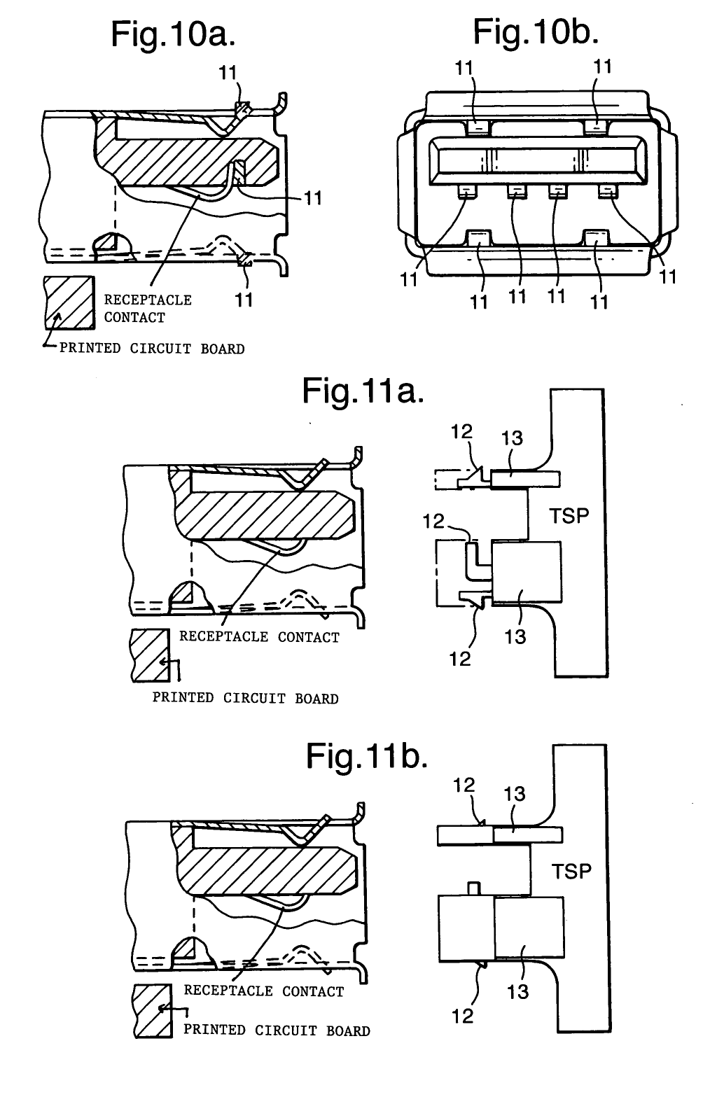

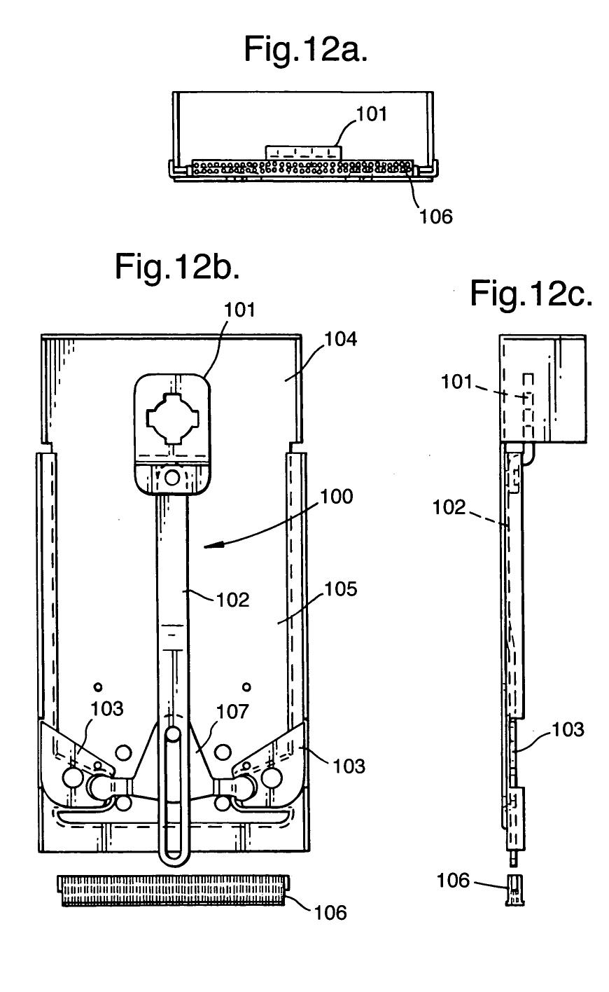

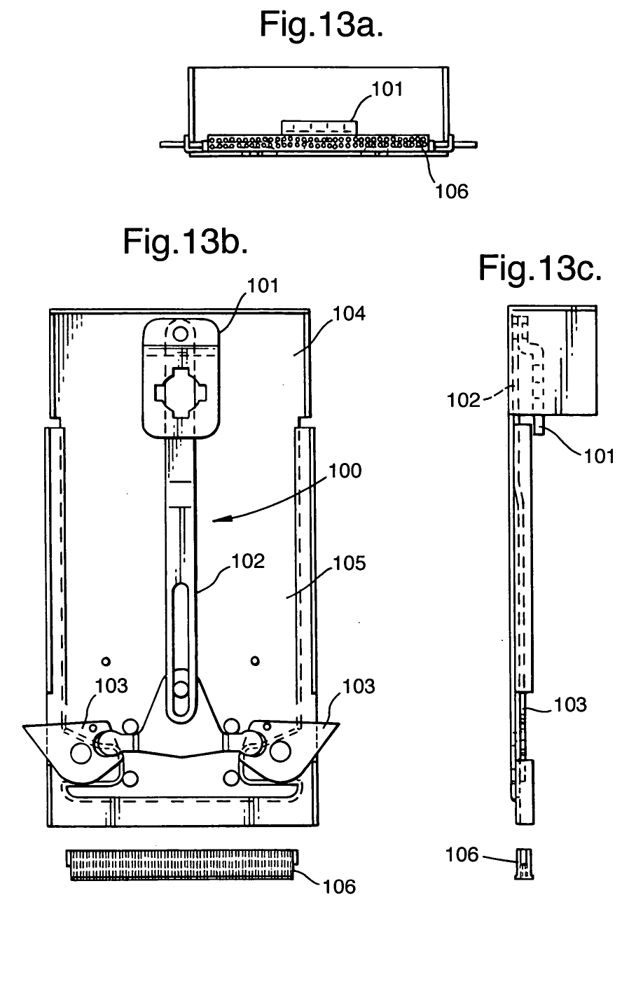

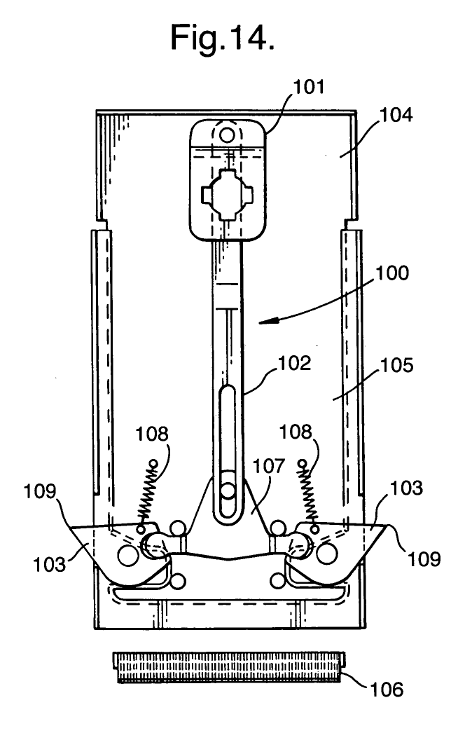

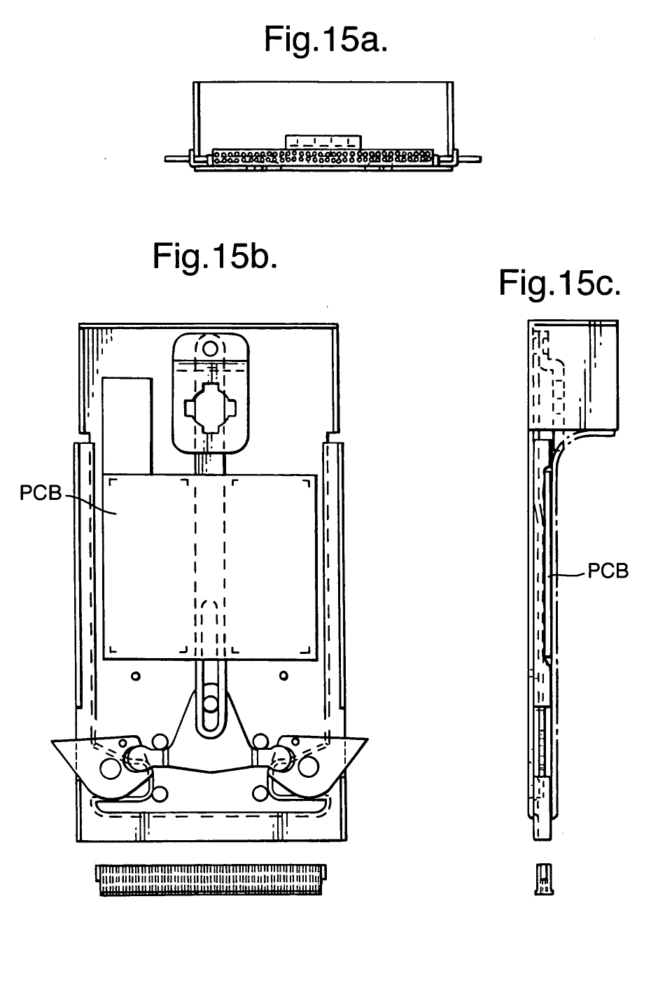

3.8 FIG. 8, Communication with the piece of equipment that is protected

The figure shows an example of a TPP made as a USB plug type “A”, with connection between all contact points in the USB and the internal electronics of the TPP, so that the TPP and the piece of equipment that is protected can communicate up to two ways. The TPP can transmit a signal having a specific ID) (and optionally a status report) to the alarm control unit, which triggers the alarm when the signal ceases or passes into another ID/state. The TPP can, as alternative, transmit a signal having an ID only when the alarm criterion has been given, and the alarm control unit can relay this signal to a receiver.

3.9 FIG. 9, Example of an on/off switch for the alarm circuit

FIGS. 9a, b and c show an example of an on/off switch (14) connected inside the front part of the TPP so that the alarm will have to be triggered in order to turn the switch off. In FIG. 9a the TPP (0) and the on/off switch (14) are seen from above. In FIG. 9b the TPP (0) and the on/off switch (14) are seen from the side. In FIG. 9c the TPP (0) and the on/off switch (14) are seen from in front.

3.10 Example of the locking mechanism

In FIG. 10 the points (11) on a standard USB receptacle which according to the invention can be used to fasten a locking mechanism thereto are shown, in the form of cavities, edges and other irregularities (11) which form friction with the locking piece.

3.11 FIG. 11a, locking piece in open position

FIG. 11a shows a locking piece (12) before it is moved into the receptacle, and the load transmission unit (13) which releases the locking piece when the alarm is deactivated.

3.12 FIG. 11b, the locking piece in locked position

FIG. 11b shows the locking pieces (12) after the TPP has been plugged into the receptacle. The locking pieces (12) move out of the TPP and into cavities (11) in the receptacle, so that the plug is locked in place in the receptacle. The locking piece can be opened via a load transmission mechanism (13) from the TPP.

### 3.13 REFERENCE NUMERALS IN THE FIGURES

0 USB plug
1 Alarm device
2 Conductors
3 Relay
4 Power source
5 Sensors
6 Signal selection switch
7 Control circuit
8 Contact pins in the TPP
9 Microswitch
10 Contact pins for the sensor
11 Cavities, edges and other irregularities (11) in the receptacle (which form friction with the locking piece)
12 Locking piece
13 Load transmission unit of the locking mechanism
14 On/off switch as key for the alarm circuit
15 Locking tongue

### First Functional Specification and Functional Description for an Embodiment of the Invention in a PCMCIA Card for a Computer

1. Introduction

This document specifies the user interface and function of the product known as LapTop Alarm for the embodiment of the invention in a PCMCIA card for a computer

2. Definitions

| | |
|---|---|
| ALARM UNIT | The actual product is an ALARM UNIT consisting |
| | of a LIGHT-EMITTING DIODE, ALARM HORN, |
| | BATTERY and 2 ALARM LOOPS. The product |
| | is operated by a KEY SWITCH. |
| KEY SWITCH | Used to turn power to the ALARM UNIT on |
| | and off. |
| LIGHT-EMITTING | Used to give visual messages to the user. |
| DIODE | |
| ALARM HORN | Used to give audible messages to the user and to |
| | give an alarm. |
| BATTERY | 12 V alkaline battery. |
| BATTERY TEST | Used to check whether the BATTERY has a |
| | satisfactory voltage level. Done automatically |
| | by the product. |
| ALARM LOOP | The ALARM UNIT has two ALARM LOOPS, of |
| | which one is a MERCURY SWITCH and one is |
| | a PCMCIA CONTACT. |
| ALARM SIGNAL | Each ALARM LOOP can generate an active or |
| | passive ALARM SIGNAL. An active ALARM |
| | SIGNAL is defined as a break of longer than 0.1 |
| | seconds. |

3. Warnings

| | | LIGHT-EMITTING |
|---|---|---|
| Type of warning | ALARM HORN | DIODE |
| BATTERY ERROR | 1 long + 3 short | 1 long + 3 short |
| WARNING | beeps (2 Hz) | flashes (2 Hz) |
| ARMING WARNING | 0.125 sec. of ALARM | On 0.125 sec. |
| | WARNING | |
| USE ERROR | 1 short beep | 1 short flash |
| WARNING | every second | every second |
| ALARM WARNING | Continuous alarm | On |

4. Operation

For full protection of a PC the following steps are taken:
1. The ALARM UNIT is inserted into the PCMCIA port.
2. The KEY SWITCH is actuated to switch on the ALARM UNIT.

A short “beep” is heard and the PC is now protected. If the ALARM UNIT is pulled out of the PCMCIA port or the PC is tilted enough the alarm will be triggered.

To cancel protection of the PC the following steps are taken:
1. The KEY SWITCH is actuated to switch off the ALARM UNIT.
2. The product is removed from the PCMCIA port.

The PC is now unprotected.

5. Functional Diagram

The diagram below shows the main modes for the principal functions of the product and possible transitions therebetween: 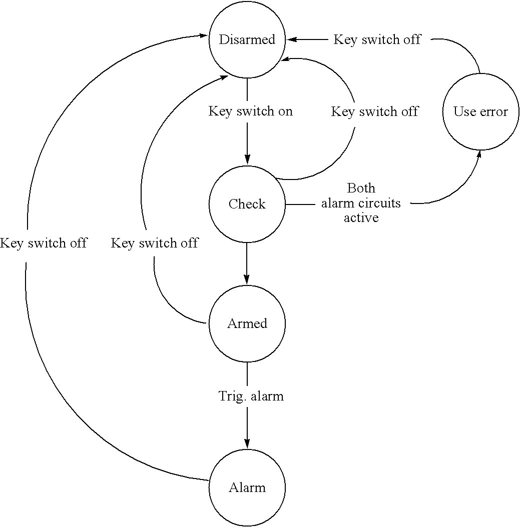
6. Detailed Functional Description

In this chapter the various modes of the ALARM UNIT will be described in more detail.

6.1 Disarmed

When the ALARM UNIT is disarmed, it is without power. The product cannot then give any form of warning.

6.2 Check

When the KEY SWITCH is turned on, the program is started in the processor. The ALARM UNIT then enters the Check mode. In this mode the following applies:
1. The LIGHT-EMITTING DIODE is switched on for 0.5 second and the BATTERY TEST is carried out at the same time.
2. If the BATTERY VOLTAGE is low, a warning is given for about 1.5 seconds by generating BATTERY ERROR WARNING.
3. If both ALARM LOOPS have active ALARM SIGNALS, it is impossible to arm the ALARM UNIT. A warning is given in that the ALARM UNIT enters the Use error mode and generates USE ERROR WARNING.
4. If one or both ALARM LOOPS have a passive ALARM SIGNAL, the ALARM UNIT will be activated to detect an ALARM SIGNAL from the ALARM LOOP or LOOPS which are passive. This is done by generating ARMING WARNING and then entering Armed mode.
5. If the KEY SWITCH is turned off, the ALARM UNIT enters the Disarmed mode.
   6.3 Armed

In the mode for Armed the following applies:
LIGHT-EMITTING DIODE, ALARM HORN and BATTERY TEST are switched off.
On active ALARM SIGNAL, the ALARM UNIT will enter a prewaming phase
1. First an ALARM WARNING is given for one second.
2. There is then a one-second pause.
3. If there still an active ALARM SIGNAL, an ALARM WARNING is given for a further one second.
4. There is then a one-second pause.
5. Then a check is made for an active ALARM SIGNAL.
   If there is still an active alarm signal, the ALARM UNIT enters the mode for Alarm.
   If there is no active ALARM SIGNAL, the ALARM UNIT will in the next 30 seconds check for a new active ALARM SIGNAL. If a new active alarm signal comes during that time, the ALARM UNIT will immediately enter the mode for Alarm. If not, the ALARM UNIT will exit the prewarning phase.
   If the KEY SWITCH is turned off, the ALARM UNIT will go into the Disarmed mode.
      6.4 Alarm

In the Alarm mode the following applies:
The ALARM UNIT generates an ALARM WARNING.
If the KEY SWITCH is switched off, the ALARM UNIT will enter the Disarmed mode.
   6.5 Use Error

In the Use error mode, the following applies:
USE ERROR WARNING is generated until the KEY SWITCH is turned off.
   Second Functional Specification and Functional Description for an Embodiment of the Invention in a PCMCIA Card for a Computer
   1. Introduction

This document specifies the user interface and function for the product known as LapTop Alarm from the company SafetyCable AS. The product is described in more detail in a separate document, 100-LTS-10-02-NO, drawn up for an embodiment of the invention in a PCMCIA card for a computer.

2. Definitions

| | |
|---|---|
| THE PRODUCT: | The PRODUCT consists of an ALARM UNIT |
| ALARM UNIT | and a KEY UNIT. |
| KEY UNIT | The ALARM UNIT has a LIGHT-EMITTING |
| | DIODE, ALARM HORN, BATTERY, |
| | LOCKING PIN and ALARM CIRCUIT. |
| | The KEY UNIT consists of a unique electronic |
| | code. |
| LIGHT-EMITTING | Used to give visual messages to the user. |
| DIODE | |
| ALARM HORN | Used to give audible messages to the user and to |
| | give the alarm. |
| BATTERY | 6 V alkaline battery. |
| BATTERY TEST | Used to check whether the BATTERY has |
| | satisfactory voltage level. |
| LOCKING PIN | Used to be able to physically release the ALARM |
| | UNIT so that it can be pulled out of the PC's |
| | PCMCIA port. |
| ALARM LOOP: | The ALARM UNIT has an ALARMS LOOP |
| MERCURY SWITCH | which consists of 2 triggering units: en |
| PCMCIA CONTACT | MERCURY SWITCH and a PCMCIA |
| | CONTACT. |
| ALARM SIGNAL | The MERCURY SWITCH or PCMCIA |
| | CONTACT are series connected. If at least one of |
| | them is active (break) this is defined as an alarm |
| | and the ALARM SIGNAL is read as active. |

3. Operation

To protect a PC with the PRODUCT, the following steps are taken:
1. The KEY UNIT is connected to the ALARM UNIT
2. The PRODUCT is inserted into the PCMCIA port
3. The KEY UNIT is disconnected

The PC is now protected. If the PRODUCT is now pulled out of the PCMCIA port or the PC is tilted sufficiently, the alarm (active ALARM SIGNAL) will be triggered.

To cancel the protection of the PC, the following steps are taken:
1. The KEY UNIT is connected to the ALARM UNIT
2. The PRODUCT is removed from the PCMCIA port

The PC is now unprotected.

4. Functional Diagram

The diagram below shows the main modes for the principal functions of the Product and possible transitions therebetween. 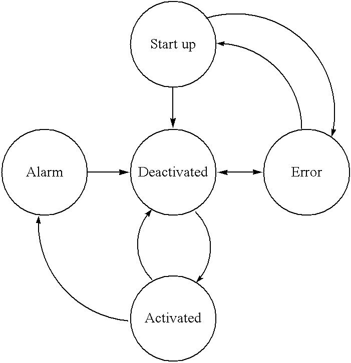
5. Detailed Functional Description

In this chapter the various modes of the ALARM UNIT will be described in more detail.

5.1 Start-Up

When the BATTERY is installed in the ALARM UNIT, the program is started in the processor. The program will restart on change of battery.

On first-time start-up of the ALARM UNIT, the following applies:
1. The ALARM UNIT will attempt to read the unique electronic code in the KEY UNIT in order to store it the processor's internal E²prom.
   If the KEY UNIT is connected, the code is read and stored. The ALARM UNIT enters the Deactivated mode.
   If an error occurs on reading the code for the KEY UNIT, the ALARM UNIT will enter the mode for Errors and warn of Code error.
      If the ALARM UNIT is connected to the PCMCIA port, and the KEY UNIT is not connected, the ALARM UNIT will enter the mode for Errors and warn of Use error.

On subsequent start-ups the ALARM UNIT will enter the Deactivated mode.

5.2 Deactivated

The mode for Deactivated is the normal position of the ALARM UNIT. In this mode the following applies:
The ALARM UNIT is not connected to the PCMCIA port, or
The ALARM UNIT is connected to the PCMCIA port and the KEY UNIT is connected.
The LIGHT-EMITTING DIODE, ALARM HORN, BATTERY TEST and LOCKING PIN and communication with the KEY UNIT are disabled.
The program is in sleep mode.
The program is set to wake up from sleep mode on connection or disconnection of the KEY UNIT and on active ALARM SIGNAL (e.g., on disconnection from the PCMCIA port).
When the program wakes up, a BATTERY TEST will be carried out (described in Chapter “0 5.5.1 Battery error”)

To activate the ALARM UNIT, the PC must not be tilted beyond the relevant threshold.

The following is steps are taken:
1. The KEY UNIT is connected to the ALARM UNIT.
   If the KEY UNIT is valid, the LIGHT-EMITTING DIODE gives a short flash
   If the KEY UNIT is invalid, there is no response
   If the KEY UNIT is disconnected, there is no response.
      2. With the KEY UNIT Connected, the ALARM UNIT is Inserted Into the PCMCIA Port.
      3. The KEY UNIT is Disconnected
   The ALARM UNIT gives three short flashes of the LIGHT-EMITTING DIODE and three short bleeps of the ALARM HORN at a frequency of 4 Hz.
   The ALARM UNIT enters the Activated mode

If the ALARM UNIT is inserted into the PCMCIA port without the KEY UNIT being connected, the ALARM UNIT enters the mode for Errors and warns of Use error.

5.3 Activated

In the Activated mode the following applies:
The ALARM UNIT is coupled to the PCMCIA port
The LIGHT-EMITTING DIODE, ALARM HORN, BATTERY TEST, LOCKING PIN and communication with the KEY UNIT are disabled
The program is in sleep mode
The program is set to wake from sleep mode on connection of the KEY UNIT and on active ALARM SIGNAL

To deactivate the ALARM UNIT the following steps are taken:
1. The KEY UNIT is connected to the ALARM UNIT
   If a valid KEY UNIT is connected, the ALARM UNIT will give one short bleep of the ALARM HORN. Then, the LIGHT-EMITTING DIODE and the LOCKING PIN will be enabled for up to three seconds, thus allowing the ALARM UNIT to be disconnected from the PCMCIA port. If the ALARM UNIT is disconnected from the PCMCIA before three seconds is up, the LIGHT-EMITTING DIODE and the LOCKING PIN are disabled. The ALARM UNIT enters the Deactivated mode.
   If the KEY UNIT is invalid, there is no response
   If the KEY UNIT is disconnected, the ALARM UNIT is reactivated.

In the Activated mode, the triggering of an alarm (active ALARM SIGNAL) will cause the ALARM UNIT to enter the Alarm mode.

5.4 Alarm

In the Alarm mode the following applies:
The LIGHT-EMITTING DIODE gives the alarm by means of flashing light
The ALARM HORN gives the alarm
A BATTERY TEST is not carried out (gives warning as long as there is sufficient voltage in the processor)
The program is set to detect connection of the KEY UNIT
The program is active (not in sleep mode)

To make the warning cease, the following is done:
1. The KEY UNIT is connected to the ALARM UNIT.
   If the KEY UNIT is valid the warning ceases and the ALARM UNIT enters the Deactivated mode. In addition, the LIGHT-EMITTING DIODE and the LOCKING PIN are enabled for up to three seconds, so that the ALARM UNIT can be disconnected from the PCMCIA port. If the ALARM UNIT is disconnected from the PCMCIA before three seconds is up, the LIGHT-EMITTING DIODE and the LOCKING PIN are disabled.
   If the KEY UNIT is invalid, the warning continues as before.
      5.5 Errors

The ALARM UNIT can warn of Battery errors, Use errors and Code errors.

5.5.1 Battery Errors

When a BATTERY TEST is carried out, it checks whether the BATTERY has satisfactory voltage level. A warning of low battery voltage is not given in the Alarm mode. In other modes, warning of low battery voltage is given in that the ALARM UNIT gives one short flash of the LIGHT-EMITTING DIODE and one short beep of the ALARM HORN every minute. If the battery voltage rises again (e.g., at higher ambient temperature) or when a new battery is put in, the warning ceases and the ALARM UNIT enters the Deactivated mode.

5.5.2 Use Error

Warning of use error is given in that the ALARM UNIT gives one short flash of the LIGHT-EMITTING DIODE and one short beep of the ALARM HORN every second. If the correct KEY UNIT is connected the warning will cease and the ALARM UNIT will enter the Deactivated mode.

5.5.3 Code Error

If there is an error in the reading of the code on first-time start-up, a warning of code error is given by the LIGHT-EMITTING DIODE flashing ten times. Then the program enters the sleep mode and will wake up if the KEY UNIT is reconnected.

In a third embodiment of the invention the invention comprises a PCMCIA card which is suitable for placing in an adapted PCMCIA card space in a computer. This embodiment is equipped with a position detector, optionally a motion detector, which through a detection circuit in the module is able to trigger a siren, preferably an acoustic transducer, which is inside or outside the PCMCIA module.

The embodiment comprises a mechanical locking device 100 which is formed by a rotatable element 101 which can be connected to a lock cylinder, an operating arm 102 which in a hinged manner is connected to the rotatable element 101, an articulated piece 107 having a hinged and sliding connection to the operating arm 102 and a pair of locking tongues 103 which on displacement of the articulated piece 107 can be turned from a recessed position to a projecting position. The locking mechanism functions so that when the rotatable element 101 is turned 180° from the first position to a second position, a longitudinal displacement of the operating arm 102 is effected, so that the operating arm 102 comes into engagement with the articulated piece 107, thus turning the locking tongues 103 so that they enter a closed position with the locking tongues recessed in the module. With the locking tongues recessed in the module, the locking tongues cannot come into engagement with any of the surroundings, so that the PCMCIA module can then be freely withdrawn from the computer.

The lockable PCMCIA module itself is so dimensioned that a part of the module can project from a computer when it is placed in the computer's PCMCIA slot, a first part 105 of the lockable PCMCIA module being adapted to be in its entirety inside the computer's PCMCIA slot, whilst a second part 104 may be on the outside of the computer's PCMCIA slot.

The locking tongues 103 are rotatably arranged on the base plate 104, 105 of the lockable PCMCIA module and are also connected to the base plate 104, 105 through a spring arrangement 108. In an open position, i.e., a position which locks the PCMCIA module to the computer's PCMCIA slot, the rotatable element 101 has been turned 180° to pull the operating arm 102 as far as possible from the articulated piece 107, so that the locking tongues 103 are pulled into the open position and at the same time pull the articulated piece 107 forwards.

The locking means in the lockable PCMCIA module is so dimensioned that it still allows room for the installation of an electronics module and a contact 106 which can be located on the side of the lockable PCMCIA module as shown in the figure. The electronics module can comprise the aforementioned position detector or motion detector and a siren or acoustic transducer, and necessary power supply can either be located in the first part 105 or in the second part 104 of the lockable PCMCIA module.

The locking tongues 103 are provided with a sharp or pointed area 109 and can engage with the side walls in a PCMCIA slot when the invention's lockable PCMCIA module has been inserted in a PCMCIA slot in a computer.

The embodiment of the invention which is shown in the attached drawings comprises a locking means which makes use of a rotatable element 101 which is well suited for connection to a mechanical key lock with a standard lock cylinder. However, the rotatable element 101 may be replaced by a solenoid or another electrically operated operating element which can be connected to the articulated piece 107 in order to place the locking tongues in a closed position when it is desirable to remove the lockable PCMCIA module from a computer's PCMCIA slot. If the rotatable element 101 is replaced by an electric actuator it would be advantageous to equip the module with an electronic key means which, for example, may be formed by an electronic key unit which is inserted in to a reading device in the lockable PCMCIA module, or a wireless key transfer means, or another means for entering the key code into the lockable PCMCIA module to actuate the actuator element in order to bring the locking tongues 103 into a closed position.

A typical PCMCIA module comprises a guiding means which only allows the PCMCIA module to be inserted into a PCMCIA slot in a computer in one position. The lockable PCMCIA module according to the invention can, however, be arranged so that it is reversible, so that it may be freely inserted in any PCMCIA slot in a computer which has two adjacent PCMCIA slots, and can thus be chosen to simply remain locked in the PCMCIA slot or to remain locked and at the same time block a possible removal of a standard PCMCIA module in an adjacent PCMCIA slot in that the slightly larger part 104 of the lockable PCMCIA module is arranged so that it prevents removal of a standard PCMCIA module in an adjacent PCMCIA slot.

[image]

“NOISE FILTER”

If there is noise from an Hg loop (i.e., short contact periods), I believe that we can set a minimum requirement as regards output from a Hg loop, if the output is to be registered as an “illegal” output. E.g., if the output is shorter than 0.1 seconds, an alarm warning is triggered and then an alarm. 0.1 seconds is suggested because a thief will not manage to move the laptop very much in that time, and also I suppose that individual noise signals from the Hg loop will not last longer either.

In addition, I would suggest a new functionality which we can call, e.g., “ALARM WARNING”.

“ALARM WARNING”

In activated state and >0.1 seconds output from the Hg loop, the following will happen:
two-seconds pause
3×beep again (same volume as the alarm)
two-seconds pause
alarm returns to new (and extra sensitive) alarmed state which lasts 60 seconds.

In the “extra sensitive” state, the alarm will be triggered for full at Hg effect >0.1 seconds.
after 60 second in the “extra sensitive” state, the alarm returns to its normal activated state.

1. The TPP can be controlled by the piece of equipment it protects via the port to which it connected. This allows, inter alia, a reduction in the size of the unit.

2. The TPP is simple to disconnect from and connect to the piece of equipment to be protected, which is necessary for mobile equipment (portable electrical units).

3. The user has the opportunity to lock the contact with the alarm electronics in a communication port on the piece of equipment to be protected in such manner that the thief would have to destroy essential parts of the product in order to be able to steal it.

4. The alarm device is protected from an unauthorised person dampening the alarm signal by putting the alarm device in a bucket of water or the like.
If the alarm device had been placed on the outside of the piece of equipment to be protected or, e.g., merely been fastened to the piece of equipment with a wire, chain, adhesive, tape or in some other manner which makes it easily accessible to the thief, the thief could have put the alarm device in a vessel containing water, thereby preventing the alarm signal from reaching the desired receiver, when he pulled it out or in some other way removed the theft protection unit from the device to be protected.

5. Physical destruction of the alarm device by using, e.g., blows of a hammer sledgehammer, by drilling, using pliers etc. will be made difficult.
The device to be protected stands in the way of the tool when the attempt is made, thereby preventing the tool from reaching the critical components.
The device to be protected may be destroyed instead of the alarm device during an attempt of this kind to tamper with the device

6. It is more difficult to dampen the alarm signals by covering the alarm device with alarm signal muffling material as for instance a bundle of wet cloth, metal cladding or the like:
Because the alarm signal muffling material does not reach around the whole alarm device.
Because the area around the theft protection plug receptacle on the electrical device is not normally completely level (because of the frame around the receptacle, other contacts/cables and chassis screws etc.), which makes it difficult to suppress the alarm signal even with an efficient muffling material.
On a number of electrical devices in the area of application of the theft protection plug, there are gaps and holes around the receptacle which will admit the alarm signals into the actual casing around the device to be protected, so that the alarm signals from the alarm device are not dampened sufficiently in all instances, provided that the alarm device is located in the theft protection plug.

7. If the alarm signal is an audible signal, the sound from the signal unit will be amplified by reflection against the device chassis (in the area around the theft protection plug receptacle).
Sound holes or a sound diaphragm in connection with the alarm device can be directed towards the chassis of the device, so that the amplitude of the sound waves reflected from the chassis will be amplified by interference in the points of intersection between the sound waves which cross.

8. Sound holes can be made in front of the rear part of the theft protection plug, so that when an unauthorised person begins to pull the theft protection plug out of the device to be protected, the following happens:
The sound is amplified considerably in that it is passed directly from the resonance chamber in the rear part of the theft protection plug out through open holes.
The sound from the resonance chamber is passed directly into the wall of the device chassis, which reflects it so that the amplitude is further amplified because of interference.
According to the inventor, open sound holes are only suitable when placed in front of the rear part of the theft protection plug or in the front part of the theft protection plug, because unauthorised persons could otherwise fill the resonance chamber with sound-dampening material, as for instance foam, liquid or the like. There is 1-3 mm of air in this gap also, which lets sound out straight out of the resonance chamber even when the theft protection plug is fully inside the device receptacle.
